(19) United States
(12) Patent Application Publication
(10) Pub. No.: US 2019/0142561 A1
(43) Pub. Date: May 16, 2019

(54) ZERO MOMENT ADJUSTER

(71) Applicant: Naoki NISHIHAMA, Hyogo (JP)

(72) Inventor: Naoki NISHIHAMA, Hyogo (JP)

(21) Appl. No.: 16/300,332

(22) PCT Filed: May 24, 2017
(86) PCT No.: PCT/JP2017/019310

§ 371 Date: Nov. 9, 2018

(30) Foreign Application Priority Data
May 27, 2016 (JP) 2016-106304

(51) Int. Cl. A61C 19/045

(52) U.S. Cl. CPC A61C 19/045

(57) ABSTRACT

A zero moment adjuster, with which an occlusal curve inherent in a patient can be reproduced within the buccal cavity easily and accurately, includes a base frame, face-bow mounting parts, a face bow, a mouthpiece, a fixing section for fixing the face bow on the face-bow mounting parts at a prescribed mounting angle, which is detachably fitted to the one face-bow mounting part, earpiece mounting parts, earpieces, a pad part, and a reference point indicating part for indicating an occlusion force concentration portion, wherein the mouthpiece is formed in the shape of a curved surface along an occlusion spherical surface whose center is a point on an occlusion line passing through the occlusion force concentration portion and being parallel to side frames, and the prescribed mounting angle is designed to allow the mouthpiece to be positioned on an occlusion curved surface within the buccal cavity.

### TECHNICAL FIELD

The present invention relates to a zero moment adjuster (also called an occlusion curve measuring device or an occlusion contact position measuring device), and more particularly, to a zero moment adjuster suitable for use in dental treatment for improper occlusion, edentulous jaw, oligodontia and the like.

### BACKGROUND ART

In denture base treatment or implant treatment for edentulous jaw, oligodontia and the like, it is extremely important to impart ideal occlusion to dentures or pontics. Conventionally, this occlusion impartment has been considered based on the anatomic form of mainly hard tissue in the buccal cavity or surrounding the buccal cavity and the universal chewing movement of the lower jaw represented by combining several virtual reference lines and planes. And in actual treatments, dental doctors or technicians reconstruct occlusion of each patient on the basis of such universal chewing movement.

The reconstruction of occlusion of each patient by the dental doctors or technicians has been implemented depending on experience and intuition of the dental doctors or technicians. However, there is nothing to be a reference of the direction and magnitude of strong clenching force at the time of actual occlusion. Therefore, it is extremely difficult to quantitatively construct ideal occlusion inherent in each patient. For example, in the case of producing a denture base for a patient suffering from edentulous jaw, it takes fairly much time and labor, while the patient's degree of satisfaction with the produced denture base is low.

In order to solve the above problem, the inventor of the present invention focused attention on a resultant of forces generated by actual occlusion, and developed a method which makes it possible to efficiently produce, particularly a full denture of each patient with ease and in a short period of time, and an articulator and a face bow used therein, which have been already applied for patents (see the below-mentioned Patent Documents 1-3).

Using the articulator and the face bow developed by the inventor of the present invention, it is possible to construct close-to-ideal occlusion more easily and in a shorter period of time as compared to the conventional methods, leading to great popularity in the actual treatment scenes. However, it cannot be said that the face bow widely used at present is sufficiently satisfactory. In order to construct ideal occlusion, troublesome work is practically required, and experience and skill are also required.

Therefore, the inventor of the present invention tried further improvement and developed a dental face bow for efficiently producing a denture base whereby ideal occlusion can be obtained, and filed a patent application. It has been already patented (see the below-mentioned Patent Document 4). Using this dental face bow, it became possible to efficiently produce a denture base whereby close-to-ideal occlusion can be obtained more easily and in a shorter period of time as compared to the conventional face bow.

### Problems to be Solved by the Invention

It became possible to reproduce close-to-ideal occlusion more easily and in a shorter period of time using the dental face bow described in Patent Document 4 as compared to the conventional methods. However, when using the above dental face bow, it is not easy to position a mouthpiece to be an occlusion reference piece attached to a rotary frame on an occlusion curved surface inherent in a patient with high accuracy while rotating the rotary frame, leading to still required skill and labor of the operators.

### PRIOR ART DOCUMENT

### Patent Document

Patent Document 1: Japanese Patent Application Laid-Open Publication No. 2003-024348

Patent Document 2: Japanese Patent Application Laid-Open Publication No. 2003-190186

Patent Document 3: Japanese Patent Application Laid-Open Publication No. 2003-245291

Patent Document 4: Japanese Patent Publication No. 4876276

### SUMMARY OF THE INVENTION

### Means for Solving Problem and the Effect

The present invention was developed in order to solve the above problem, and it is an object of the present invention to provide a zero moment adjuster whereby an occlusion curve inherent in a patient can be reproduced extremely easily and with high accuracy, being more excellent in ease of use.

The inventor of the present invention focused attention on that the resultant force generated by a person's normal jaws and teeth, and the masticatory muscle adhered thereto acts only on a universal fixed place within the skull, and with many years of research and a great number of clinical cases, he found that the resultant force in a case where the clenching force causes no moment on the upper and lower jaws is directed from the center point between the left and right lower jaw angles to the center point of the frontal sinus.

The muscles to act at the time of occlusion are musculus masseter (M. masseter) Mm and musculus temporalis (M. temporalis) Mt as shown in FIGS. 6 and 7. The forces generated by these muscles are vectors each having prescribed direction and magnitude. It was found that the resultant of these forces is normally directed toward a point in the neighborhood of the front edge portion of the frontal sinus (immediately above the nasion) (called an “N point”) as shown in FIGS. 6-8, though there are slight differences among individual patients.

In FIGS. 6 and 8, two-dimensionally showing the side of the head, reference signs Pa, Pb, and Pc represent an occlusion point of anterior teeth, an occlusion point of back teeth, and a point of condyle, respectively. In the figures, the occlusion force acting on the occlusion point of back teeth Pb and the occlusion force acting on the condyle point Pc are vectors having a direction represented by L therein, and the relationship between these forces and the resultant force F thereof is as shown in the following equations.

Reference sign O in the figure represents the N point. The occlusal curve is on a spherical surface whose center is this point O.

N₁ sin θ₁=N₂ sin θ₂

N₁ cos θ₁+N₂ cos θ₂=F

2N₁ cos φ₁·sin θ₁=2N₂ cos φ₂·sin θ₂

2N₁ cos φ₁·cos θ₁+2N₂ cos φ₂·cos φ₂=F

Here, the resultant force at the time of occlusion of every patient is not directed to the point O (N point). It was also found that, owing to senescence/absorption of bones with aging and the like, the point to which the resultant force at the time of occlusion is directed gets gradually closer to a point P on a line L connecting between the N point and the point P of the lower jaw angle (also called “an occlusion line”, “a resultant line”, or “a vector axis”). Even if the point to which the resultant force at the time of occlusion is directed changes with aging and the like, the occlusal curve of each patient can be grasped by visual observation of remaining teeth, gums and the like.

Therefore, when drawing a circular arc (a spherical surface in actual) whose center is a point on the occlusion line L (its position is slightly different among patients), each occlusion point in ideal occlusion should gather on the circular arc (on the curved surface). The present invention was accomplished based on such knowledge, which makes it possible to extremely easily diagnose and reproduce a state of ideal occlusion.

That is, a zero moment adjuster according to a first aspect of the present invention is characterized by comprising a base frame having a pair of left and right side frames arranged along both sides of the head of a patient and a lateral frame connecting between the pair of left and right side frames, face-bow mounting parts attached to the side frames, a face bow which is detachably mounted on the face-bow mounting parts, a mouthpiece mounted on the face bow to be inserted into the buccal cavity of the patient, a fixing section for fixing the face bow on the face-bow mounting parts at a prescribed mounting angle, which is detachably fitted to the face-bow mounting part, earpiece mounting parts installed at the side frames, earpieces mounted on the earpiece mounting parts, a pad part for supporting the base frame to be applied in the neighborhood of between the eyebrows of the patient, being provided in a center portion of the lateral frame, and a reference point indicating part for indicating an occlusion force concentration portion set in the neighborhood of the nasion of the patient, being provided in the center portion of the lateral frame, wherein the mouthpiece is formed in the shape of a curved surface along an occlusion spherical surface whose center is a point on an occlusion line which passes through the occlusion force concentration portion and is parallel to the side frames, and the prescribed mounting angle is an angle designed to allow the mouthpiece to be positioned on an occlusion curved surface within the buccal cavity.

Using the zero moment adjuster according to the first aspect of the present invention, with the fixing section which can be attached to/detached from the face-bow mounting part, the face bow can be easily fixed on the face-bow mounting parts at a prescribed mounting angle, that is, at an angle designed to allow the mouthpiece to be located on an occlusion curved surface within the buccal cavity.

Accordingly, it is possible to locate the mouthpiece on the occlusion curved surface within the buccal cavity with ease and high accuracy, to measure the occlusion curve of a patient efficiently, and to reproduce an ideal occlusion state inherent in the patient easily and in a short period of time, leading to enhancement in efficiency of dental treatment such as occlusion diagnosis.

The zero moment adjuster according to a second aspect of the present invention is characterized by the face-bow mounting part, having a fixed part to be fixed to the side frame and a hole formation part in which a plurality of holes for adjusting the mounting position of the face bow are formed, and the fixing section, having a fitting part which can be fitted to the hole formation part and a holding part for holding the face bow at the prescribed mounting angle, wherein a plurality of protrusion parts which can be engaged in the plurality of holes in the hole formation part are formed on the fitted surface of the fitting part, and a protrusion part provided at the end of the face bow is also arranged thereon, according to the zero moment adjuster according to the first aspect of the present invention.

Using the zero moment adjuster according to the second aspect of the present invention, by inserting the plurality of protrusion parts formed on the fitting part of the fixing section and the protrusion part provided at the end of the face bow into the holes formed in the hole formation part of the face-bow mounting part, the face bow can be easily mounted on the face-bow mounting parts at the prescribed mounting angle and at the position of a curvature radius (an occlusal vertical dimension) inherent in the patient, and the occlusion curve and occlusal vertical dimension inherent in the patient can be reproduced extremely easily and accurately by one-touch fitting.

The zero moment adjuster according to a third aspect of the present invention is characterized by the face bow which is formed approximately in a U-shape, the fixing section which is fixed at one end of the face bow, and a height indicating device for indicating a mounting height of the face bow, being rotatable to the face bow, which is provided at the other end of the face bow, according to the zero moment adjuster according to the first or second aspect of the present invention.

Using the zero moment adjuster according to the third aspect of the present invention, by the fixing section fixed at one end of the face bow, the face bow can be fixed on the face-bow mounting parts at the prescribed mounting angle. And by the height indicating device provided at the other end of the face bow, the mounting height of the face bow can be adjusted with high precision, the face bow can be easily mounted on the face-bow mounting parts at the prescribed mounting angle and at the position of a curvature radius (an occlusal vertical dimension) inherent in the patient, and the occlusion curve and occlusal vertical dimension inherent in the patient can be reproduced extremely easily and accurately by one-touch fitting.

### BRIEF DESCRIPTION OF DRAWINGS

FIG. 1 is an elevation view of a zero moment adjuster according to an embodiment of the present invention;

FIG. 2 is a plan view of the zero moment adjuster according to the embodiment;

FIG. 3 is a cross-sectional view taken along line III-III of FIG. 1;

FIG. 4 is a perspective view of a face bow and a fixing section of the zero moment adjuster according to the embodiment;

FIG. 5 shows a tooth row of the upper jaw in a state where a mouthpiece of the zero moment adjuster according to the embodiment is inserted in the buccal cavity of a patient, wherein FIG. 5(a) is a bottom view thereof, and FIG. 5(b) is an elevation view thereof;

FIG. 6 is a side view of the skull, two-dimensionally expressing a resultant of occlusion forces;

FIG. 7 is an elevation view of the skull, showing masticatory muscle;

FIG. 8 is a side view of the skull, two-dimensionally expressing a resultant of occlusion forces;

FIG. 9 is a perspective view showing an example of an articulator suitable for use in producing a denture base with the zero moment adjuster according to the embodiment;

FIG. 10 is a side view of the articulator shown in FIG. 9;

FIG. 11 is a perspective view showing a state where a wax rim is mounted on the articulator;

FIG. 12 shows a tooth row unit, wherein FIG. 12(a) is a plan view thereof, and FIG. 12(b) is a perspective view thereof; and

FIG. 13 is a plan view of a denture base.

### MODE FOR CARRYING OUT THE INVENTION

The embodiment of the zero moment adjuster according to the present invention is described below by reference to the Figures. The present invention is not limited to the below-described embodiment. The shape, structure and the like of each component disclosed in the below embodiment are preferred examples, and other shapes, structures and the like thereof are included in the technical scope of the present invention, as far as they have similar effects.

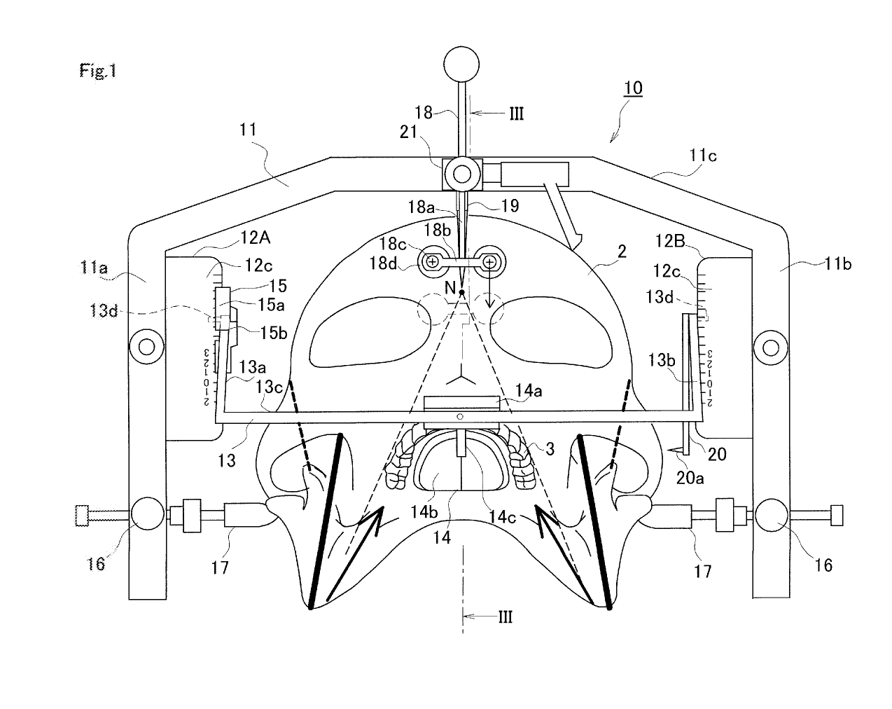

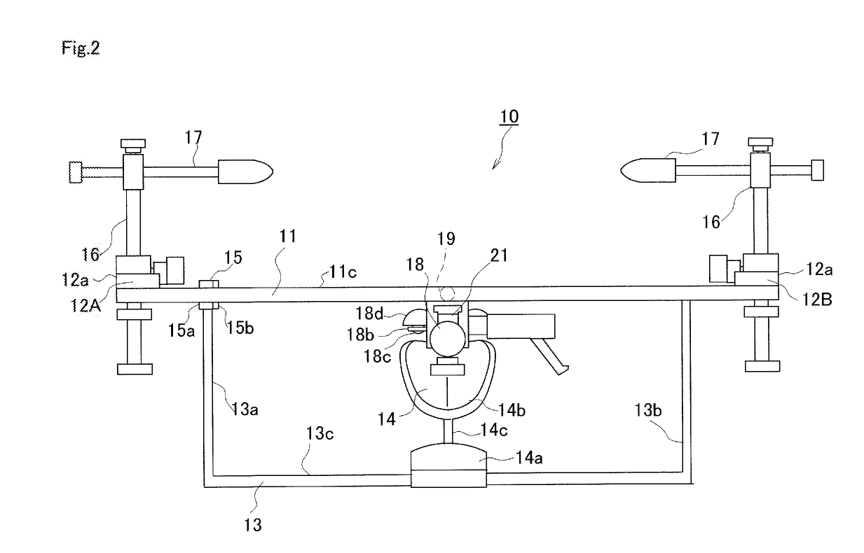

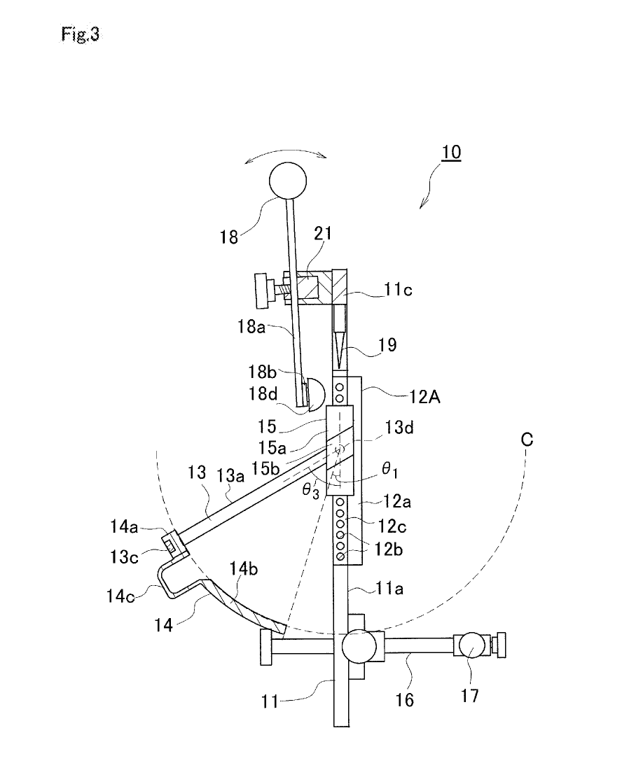

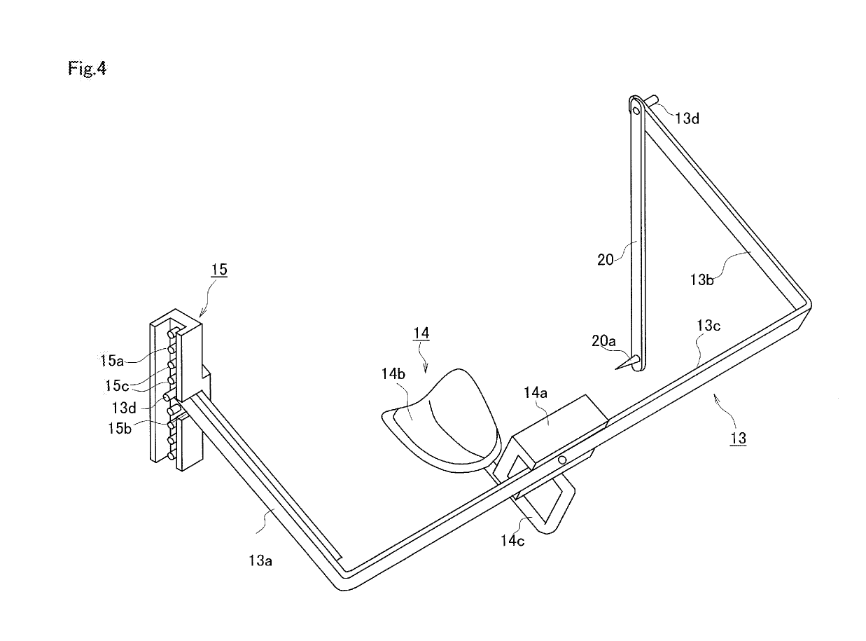

FIG. 1 is an elevation view of a zero moment adjuster according to an embodiment, FIG. 2 is a plan view thereof, and FIG. 3 is a cross-sectional view taken along line III-III of FIG. 1. And FIG. 4 is a perspective view showing a face bow and a fixing section of the zero moment adjuster according to the embodiment.

A zero moment adjuster 10 according to the embodiment is used as a vector analyzer (a zero moment determining device) to be put on the face of a patient for examining the direction of occlusion force, that is, for conducting analyses of occlusion force.

The zero moment adjuster 10 comprises a base frame 11, having a pair of left and right side frames 11a and 11b arranged along both sides of the head 2 of a patient and a lateral frame 11c connecting between the upper portions of the pair of left and right side frames 11a and 11b, and a pair of left and right face-bow mounting parts 12A and 12B attached to the side frames 11a and 11 b, respectively.

The zero moment adjuster 10 further comprises a face bow 13 which can be attached to/detached from the face-bow mounting parts 12A and 12B, a mouthpiece 14 mounted on the face bow 13 to be inserted into the buccal cavity of the patient, and a fixing section 15 for fixing the face bow 13 on the face-bow mounting parts 12A and 12B at a prescribed mounting angle and at any given occlusion height, which can be attached to/detached from the one face-bow mounting part 12A.

The zero moment adjuster 10 further comprises earpiece mounting parts 16 installed at the lower portions of the side frames 11a and 11b, respectively, in the front-back direction, earpieces 17 mounted on the rearward side end portions of the earpiece mounting parts 16 in the right-left direction, a pad part 18 for supporting the base frame 11 to be applied in the neighborhood of between the eyebrows of the patient, being provided in a center portion of the lateral frame 11c, and a reference point indicating device 19 for indicating an occlusion force concentration portion N set in the neighborhood of the nasion of the patient, being provided in the center portion of the lateral frame 11c. Reference numeral 3 in FIG. 1 represents the upper jaw tooth row of the patient.

The base frame 11 is made of material with rigidity and strength to a certain degree such as metal or plastic, approximately in an inverted U-shape. The side frames 11a and 11b are used as lateral vector axes indicating the direction of a resultant force at the time of occlusion in a side view.

The face-bow mounting parts 12A and 12B each have a fixed part 12a to be fixed to the backside of the side frame 11a or 11b, and a hole formation part 12c in which holes 12b for adjusting the mounting height position of the face bow 13 are formed at established intervals on the inside surface thereof. The hole formation part 12c is arranged on the inside surface of each of the side frames 11a and 11b. On the front of the hole formation part 12c, numerical values indicating the height levels are noted at the positions where each of the holes 12b is formed.

The face bow 13 has left and right side frames 13a and 13b, and a lateral frame 13c, which is made of a thin frame member with rigidity and strength to a certain degree such as metal or plastic, approximately in a U-shape. At the center of the lateral frame 13c of the face bow 13, the mouthpiece 14 is mounted. At the end portions of the side frames 13a and 13b of the face bow 13, protrusion parts 13d which can be engaged in the holes 12b in the hole formation parts 12c are provided outwardly in the horizontal direction.

At the end of the one side frame 13a of the face bow 13, the fixing section 15 is fixed, while at the end of the other side frame 13b thereof, a height indicating device 20 for indicating the mounting height of the face bow 13 (the occlusion height of the patient, i.e., the curvature radius inherent in the patient), which is rotatable to the face bow 13, is provided. The tip portion of the height indicating device 20 is provided with an indication pin 20a.

The face bow 13 is mounted on the face-bow mounting parts 12A and 12B in such a manner that the movement track of the indication pin 20a lies within a prescribed range of the temporal region of the patient, specifically, between the earhole and the condyle thereof when rotating this height indicating device 20. By such structure, an appropriate occlusal (tooth row) curve can be measured. It is also possible to provide the fixing section 15 and the height indicating device 20 to both of the side frames 13a and 13b of the face bow 13. In this case, the height indicating device 20 is installed rotatably on the inside surface of the fixing section 15.

Here, a plurality of face bows 13, each having the side frames 13a and 13b, and the height indicating device 20 which differ in length, are preferably prepared so as to be ready for appropriate selection according to the face bone structure or levels of senescence of a patient.

The fixing section (fixing member) 15 is fixed at the end of the one side frame 13a of the face bow 13, having a fitting part 15a approximately in a U-shape in a plan view which can be fitted to (engaged in) the hole formation part 12c, and a holding part (groove part) 15b for holding the face bow 13 at the prescribed mounting angle. On the fitted surface of the fitting part 15a (the fitted surface to the hole formation part 12c), as shown in FIG. 4, a plurality of protrusion parts 15c which can be fitted to (engaged in) the plurality of holes 12b in the hole formation part 12c are formed, and the protrusion part 13d provided at the end of the side frame 13a of the face bow 13 is also arranged thereon. Here, the shape of the fixing section 15 is not limited to the shape shown in FIG. 4. What is required for it is to be able to fit the face bow 13 to the face-bow mounting parts 12A and 12B, and also to be able to hold the end portion of the face bow 13 at the prescribed mounting angle.

The mouthpiece 14 comprises a mounting part 14a for its mounting on the lateral frame 11c, a mouthpiece part 14b approximately in the shape of a tongue, and a supporting part 14c for supporting the mouthpiece part 14b on the mounting part 14a.

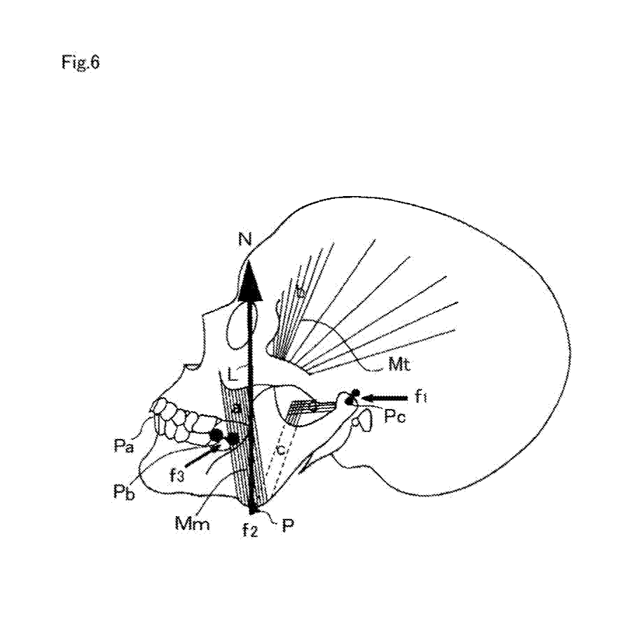

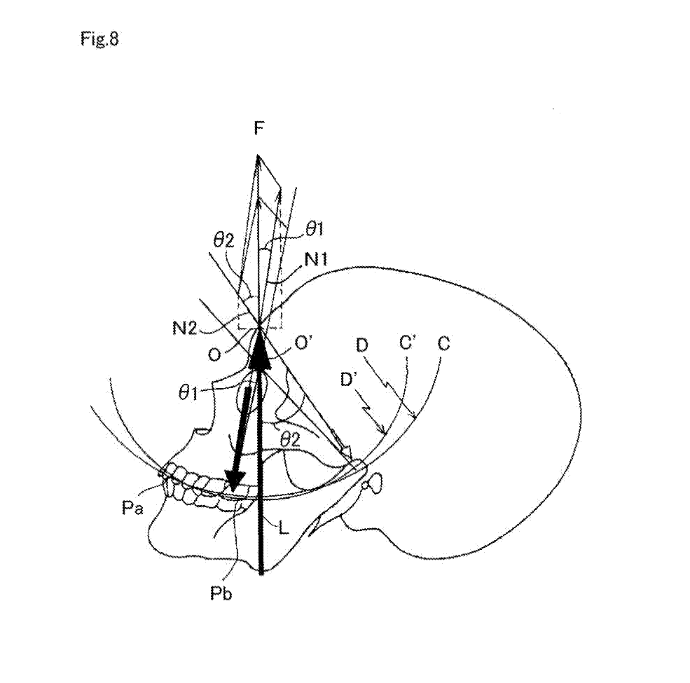

The mouthpiece 14 is formed in the shape of a curved surface along an occlusion curved surface C whose center is a point on the occlusion line L, passing through the occlusion force concentration portion N and being parallel to the side frames 11a and 11b (see FIGS. 6 and 8). The prescribed mounting angle is an angle designed to allow the mouthpiece 14 to be positioned on the occlusion curved surface C (a spherical surface whose center is a point to which the resultant force at the time of occlusion is directed) within the buccal cavity.

More specifically, the prescribed mounting angle θ₃ is designed in such a manner that an angle θ1 formed with the rear end of the mouthpiece 14, the protrusion part 13d of the face bow 13 and the side frame 11a functioning as the lateral vector axis in a side view becomes a prescribed angle, preferably about 17° (corresponding to θ₁ shown in FIG. 8), when the mouthpiece 14 is positioned on the occlusion curved surface C within the buccal cavity, as shown in FIG. 3. The angle θ₁ is approximately the same as the angle formed with the occlusion point of back teeth Pb of the patient, the occlusion force concentration portion O (N point) and the lateral vector axis coinciding with the side frame 11a. The mouthpiece 14 to be mounted can be selected in size according to the body structure/bone structure and the like of the patient.

FIG. 1 shows a situation where the face bow 13 is held at the prescribed mounting angle by the fixing section 15, the fixing section 15 is fitted to the face-bow mounting part 12A, and the mouthpiece 14 mounted on the face bow 13 is arranged along the tooth row of the upper jaw within the buccal cavity of the patient.

In the center portion of the lateral frame 11c of the base frame 11, the reference point indicating device 19 used to correctly put the base frame 11 on the head of the patient is provided. The reference point indicating device 19 is a device for indicating a point where the resultant axis at the time of occlusion of the patient and the frontal bone surface thereof intersect each other (the occlusion force concentration portion N), which is provided on the inside surface of the center portion of the lateral frame 11c in the direction parallel to the side frames 11a and 11b (the direction orthogonal to the lateral frame 11c).

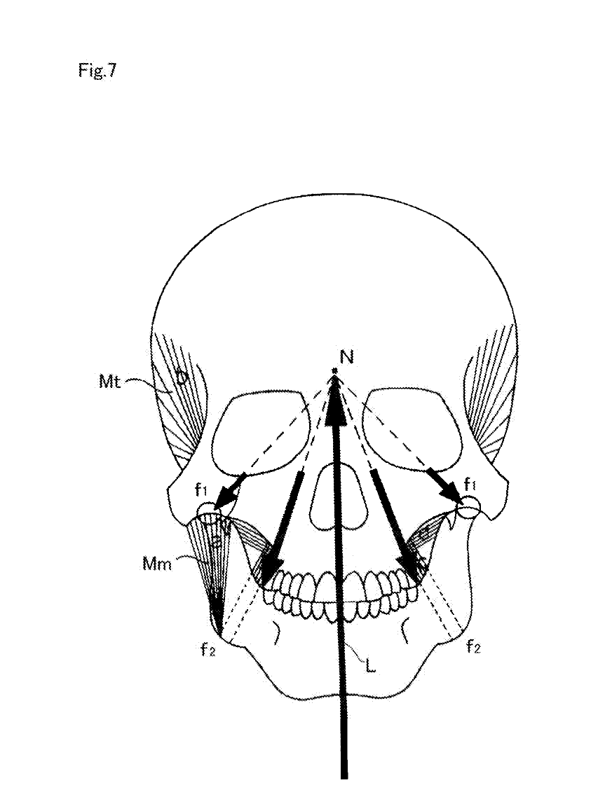

Since it is proved that the occlusion force concentration portion N, arising from a midpoint P of the left and right lower jaw angles, is positioned in the neighborhood of above the nasion of the head of a person, as shown in FIGS. 6-8, practically the base frame 11 may be fitted to the patient in such a manner that the midpoint between the left and right eyebrows of the patient is indicated thereby.

To the front side of the center portion of the lateral frame 11c of the base frame 11, a pad fitting part 21 is provided. On the pad fitting part 21, the pad part 18 for supporting the base frame 11 to be applied in the neighborhood of between the eyebrows of the patient is mounted in such a manner that the vertical position thereof can be adjusted and that the angle thereof can be adjusted in the longitudinal direction to the vertical axis.

The pad part 18 comprises an inserting shaft 18a to be inserted into the pad fitting part 21, a pad mounting plate 18b attached to the lower end of the inserting shaft 18a, a pair of left and right pad supports 18c attached to the pad mounting plate 18b, and a pair of left and right pads 18d attached to the pair of left and right pad supports 18c.

The pad 18d consists of, for example, a half sphere member made of silicon resin with elasticity and the like, which is constructed with no risk of causing pain to the patient or damage to the skin thereof, even when it is applied to the face of the patient.

At the lower portions of the side frames 11a and 11b of the base frame 11, the earpiece mounting parts 16 protruding in the orthogonal direction (front-back direction) to the side frames 11a and 11b are installed, respectively. The protrusion length (position) of this earpiece mounting part 16 can be adjusted, and on the rear end thereof, the earpiece 17 is mounted in the orthogonal direction (right-left direction) to the earpiece mounting part 16. The earpiece 17 has a smooth tip portion having elasticity, and by inserting the tip portion thereof into the ear of the patient, the base frame 11 can be supported on the head 2 of the patient.

The zero moment adjuster 10 is fitted (supported) on the head 2 of the patient using the pad part 18 and the earpieces 17. In this fitting state, the side frames 11a and 11b of the base frame 11 coincide with a projected line of the vector axis L showing the occlusion force viewed from the side. That is, it is put on the head 2 of the patient in such a manner that the plane determined by the side frames 11a and 11b, and the direction of the resultant force coincide with each other.

The mouthpiece 14 mounted on the face bow 13 is inserted into the buccal cavity (upper jaw portion) of the patient, and the face bow 13 is mounted on the face-bow mounting parts 12A and 12B using the fixing section 15 at the prescribed mounting angle and at a height suitable for the patient. Consequently, by the mouthpiece part 14b to be a reference piece, the condition of the tooth row of the patient can be diagnosed.

As a method for selecting the face bow 13 and the mouthpiece 14, for example, the maximum curvature radius inherent in the patient from the mid-lip fissure of the patient to the frontal sinus point of the forehead thereof is measured, and the face bow 13 and the mouthpiece 14 each having a smaller value (curvature radius) by 20 mm or so than the maximum curvature radius, are selected.

Or the wax rim (not shown) which the patient holds in the mouth may be fixed and retained on the face bow 13. In this case, since the angle of the face bow 13 to the base frame 11 is fixed by the fixing section 15, it is possible to easily reproduce an optimum occlusion state.

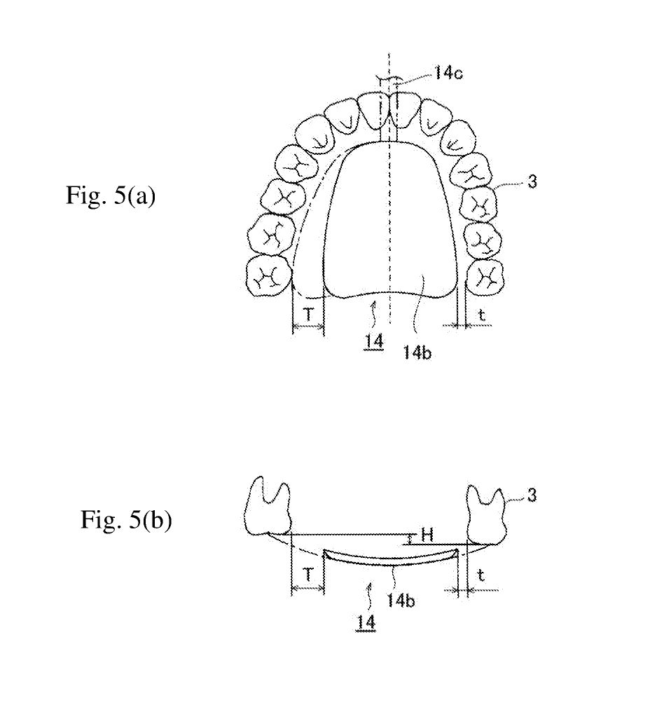

FIG. 5 shows the tooth row of the upper jaw within the buccal cavity of the patient in which the mouthpiece 14 is inserted, wherein FIG. 5(a) is a bottom view thereof, while FIG. 5(b) is a rear elevation view. Specifically, it shows a state where the mouthpiece part 14b to be a reference piece is inserted into the buccal cavity, the face bow 13 is mounted on the face-bow mounting parts 12A and 12B using the fixing section 15 at the prescribed mounting angle and at a height suitable for the patient, and the mouthpiece part 14b is arranged along the tooth row 3 of the upper jaw, that is, a state when the tooth row curve of the patient is diagnosed.

As shown in FIG. 5(a), the forward end portion of the mouthpiece part 14b is supported by the supporting part 14c. The forward end portion thereof is formed in the shape of a round convex curved surface, while both the left and right sides thereof are formed roughly in the shape of a bell so as to be slightly extended toward the back side (the lower side of FIG. 5(a)).

As shown in FIG. 5(b), the mouthpiece 14 is formed in such a manner that the cross section thereof along the right-left direction line and the cross section thereof along the front-back direction (longitudinal direction) line are curve-shaped. This curved surface is a curved plane along the ideal occlusion spherical surface, and the curvature radius of the curved surface is about 65 mm to 75 mm in the case of patients suffering from improper occlusion from age 10 to adults. And in the case of aged people or patients using a full denture, since the absorption of the jaws is large, it is approximately 65 mm regardless of race. The mouthpiece 14 may be selected properly according to the age, body structure and the like of the patient. The mouthpiece 14 is arranged with a slight clearance t inside the tooth row 3 of the patient, but in the case of the tooth row of the patient having a deviation, a large clearance represented by reference sign T in FIG. 5(b) is formed, leading to a deviation H in the vertical direction.

Or the face bow 13 on which a wax rim fixing/retaining device (not shown) having a steep tip portion is mounted instead of the mouthpiece 14 may be set at the base frame 11 so as to fix the wax rim (not shown) which the patient holds in the mouth.

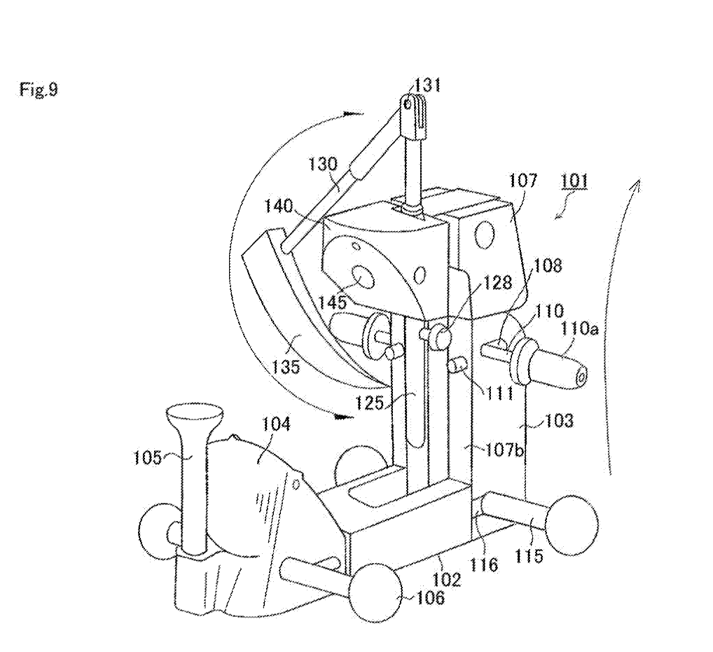

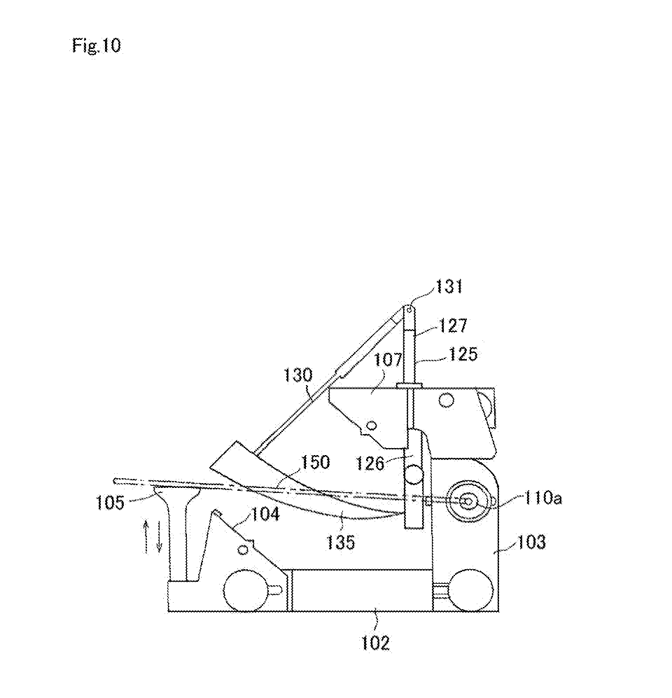

An example of an articulator suitable for use in producing a denture base with the zero moment adjuster 10 according to the present invention is shown in FIGS. 9-11. This articulator 101 has a base 102 to be placed on a plane surface. A support column 103 is erected at the rear end of the base 102, while at the front end thereof, a lower jaw supporting member 104 is provided. The lower jaw supporting member 104 is installed on the base 102 in a longitudinally adjustable manner, and by operating a shaft 106, the longitudinal position thereof and the inclination of the articulator 101 to the central axis of the longitudinal direction can be adjusted. Reference numeral 105 in the figures represents a face-bow supporting device for supporting a conventional face bow 150, but when using the zero moment adjuster 10 according to the present invention, it is not required.

The support column 103 consists of a pair of left and right frames erected side by side at an interval therebetween, and in the interval portion of the support column 103, a rotary member (moving support) 107 is supported rotatably by an axle 110. Knobs 110a, being equivalent to the jaw joints, are fixed to the axle 110 at each of the left and right sides of the rotary member 107, and the axle 110 is engaged in a longitudinally movable manner in a lateral slot 108 disposed in the support column 103.

On the end portion of the knob 110a, the portion to be engaged in the ear of the earpiece 17 of the zero moment adjuster 10 can be mounted. A bolt 111 is a longitudinal position adjusting section for determining the longitudinal position of this axle 110, and it is arranged on each of the left and right frames of the support column 103. And through a spring housed in the slot 108, each of the bolts 111 presses the axle 110 elastically. The upper portion of the rotary member 107 is bent forward, while in the lower portion thereof, a leg part 107b is provided. The leg part 107b of this rotary member 107 is limited in its rearward movement by a shaft 115. The rotary member 107 is restrained from rotating by this shaft 115, so that the vertical angle of the rotary member 107 is maintained at a prescribed angle.

The shaft 115 is constantly pressed rearward by a spring housed in a longitudinal slot 116 disposed in the support column 103. The shaft 115 is provided on each of the left and right sides, whereby the direction of the rotary member 107 can be adjusted. Since on the upper front of the rotary member 107, an upper jaw model is mounted, the force of rotation in a counterclockwise direction shown in FIG. 9 acts because of the weight thereof. However, the rotation is restrained by the shaft 115, so that the vertical inclination angle is kept at a prescribed angle. On the other hand, through the rotary member 107, a vertical rod 125 is inserted. This rod 125 has a double structure of an outside tube 126 and an inner axle 127. The inner axle 127 is supported in such a manner that the vertical position thereof can be adjusted and that it can axially rotate, and to the upper portion thereof, an arm 130 is installed with an axle 131 in a vertically rotatable manner. Reference numeral 128 represents a screw for fixing the outside tube 126 and the inner axle 127.

The arm 130 is adjustable in length, and to the free end portion thereof, a circular-arc-like pawl (an occlusal curve liner) 135 is attached. Every pawl 135 has an arm with its predetermined length, and it is designed to have a radius appropriate to the circular arc when it is attached to the arm 130 of the articulator 101.

A plurality of arms 130 (with the pawl 135) which differ in length are preferably prepared so as to be ready for appropriate replacement according to the body structure, the levels of senescence and the like of the patient.

To the front end of the forward projecting portion of the rotary member 107, an upper jaw supporting member 140 is provided. To the lower surface of the upper jaw supporting member 140 and the upper surface of the lower jaw supporting member 104, respectively, magnets 145 for attracting a model in which an iron piece is embedded are attached.

A method for producing a denture base for a patient using this articulator 101 and the zero moment adjuster 10 is specifically explained in outline below.

First, a base is produced by a well-known method. As a method for producing a base, an impressing agent is placed on a prescribed tray and the impression of the shape of the upper and lower gums of a patient is taken. Gypsum is poured onto this impression and a plaster model is produced. On this plaster model, a resin base is made, and using wax, the upper and lower wax rims (alveolar ridges or wax ridges) are roughly produced.

These wax rims (wax ridges) (not shown) are put into the mouth of the patient, and the patient is asked to actually bite so as to decide the centric position of the upper and lower jaws. In the state of biting the wax rims, the upper and lower wax rims (wax ridges) are joined together with wax. In this situation, the affinity with the buccal mucosa, the outward appearance and the like are adjusted, and the wax ridge is mounted on the zero moment adjuster 10. In this mounting, to the front of the wax ridge within the buccal cavity of the patient, a wax rim fixing/retaining device (a bite fork) is pressed, the steep tip portion thereof is inserted into the wax rim to fix it, and using the fixing section 15, the angles formed with the side frames 11a and 11b are kept constant for occlusion transfer.

Then, the zero moment adjuster 10 is removed from the patient, and held by a not shown face-bow base. On this base, concave portions (not shown) in which the lower end portions of the side frames 11a and 11b of the base frame 11 are engaged are formed. Therefore, by engaging the lower end portions of the side frames 11a and 11b in these concave portions, the zero moment adjuster 10 can be supported in a standing state. By placing the base on a horizontal plane such as a table surface, the side frames 11a and 11b representing the lateral vector axes are supported in a vertical state.

In the setting of the zero moment adjuster 10 to the articulator 101, the articulator 101 is arranged between the side frames 11a and 11b of the above vertically supported zero moment adjuster 10, and the wax rim for the upper jaw supported by the zero moment adjuster 10 is allowed to approach the upper jaw supporting member 140 of the articulator 101. In this case, since the rod 125 representing the vector axis of the articulator 101 is vertical, it coincides with the reference point indicating device 19 (the vector axis point) presented on the zero moment adjuster 10 in which the side frames 11a and 11b of the base frame 11 are vertically supported on the vertical line, resulting in good matching. And gypsum is poured onto the upper side of the wax rim and solidified, resulting in a plaster model.

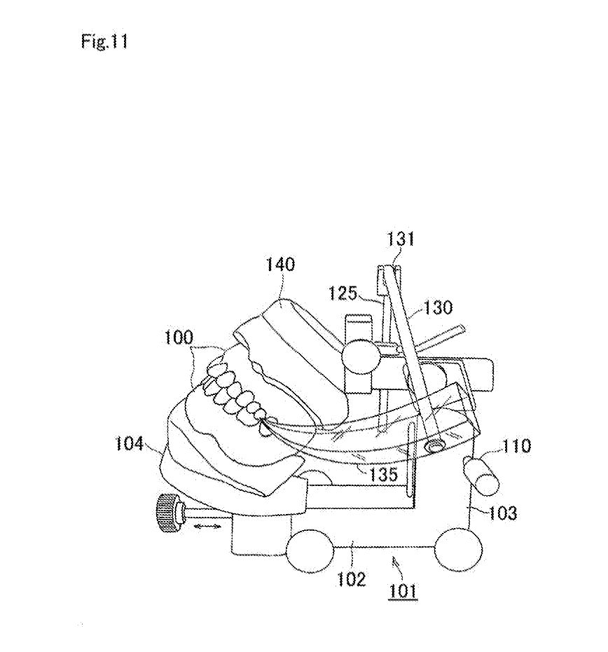

FIG. 11 shows a state of a plaster model 100 mounted on an articulator 101. This articulator 101 is designed to be fitted to the zero moment adjuster 10 according to the present invention. The shape of the articulator 101 is slightly different from the above-mentioned one, but the fundamental structure is the same as that, and the same signs are given to the same parts.

On the other hand, the distance between a point at which the incisal edge of the lower jaw central incisor of the patient contacts the lower side of the upper jaw central incisor thereof and the N point (the maximum curvature radius of the patient) has been already determined by the zero moment adjuster 10. Therefore, on the basis of this distance, on the unified wax rim (wax ridge) of upper and lower jaws set in the articulator 101, a curve is drawn by a pawl 135 of the tip portion of an arm 130. At this time, a rod 125 supporting the arm 130 can be rotated in its axial direction, and since the arm 130 is supported rotatably with an axle 131 as center, a three-dimensional circular arc can be drawn on the wax ridge by rotating it with the axle 131 as center. The position of the axle 131 supporting the arm 130 is equivalent to the N point, and the drawn circular arc represents an occlusal curve of the patient. It is also possible to install the arm 130 to the rod 125 in a three-dimensionally rotatable manner using an adjustable joint.

Since the skull of the patient differs among individuals, the length of the arm 130, the shape/size of the pawl 135 (it is convenient if multiple kinds of pawls have been prepared for appropriate replacement), the longitudinal position and vertical inclination angle of a rotary member 107, the longitudinal position of a lower jaw supporting member 104, the longitudinal position of an upper jaw supporting member 140 and the like in the articulator 101 are appropriately adjusted so as to obtain ideal occlusion.

Along the drawn occlusal curve, the wax ridge is correctly separated into the upper and lower wax ridges. Thereafter, to the wax ridges, dentures are attached along the circular arc. Specifically, a denture row of the upper jaw is put on the wax ridge of the lower jaw and provisionally fixed. On the other hand, the wax ridge of the upper jaw is washed with hot water so as to cause its resin base to be exposed. The clearance between the denture row and the resin base is provisionally filled with resin on the articulator 101. Then, only the upper jaw is removed from the articulator 101, and by pouring resin into the clearance as it is, the denture row is made in one body.

Then, the denture row of the lower jaw is fixed. In this fixing, it is only necessary to arrange the denture row in accordance with the upper jaw and fix the same. The procedure is almost the same as that of the upper jaw. Thus, a denture base in which the base and the denture row are united can be obtained. Finishing such as polishing required for this denture base results in a product.

By the way, using the zero moment adjuster 10 according to the present invention, it is not necessary to carry out cephalometric photography of the temporal region of the patient like a conventional method, but depending on the cases, the cephalometric photography may be carried out for reference purposes. Or as an easy method, without such cephalometric photography, four dentures of the upper/lower and right/left are provisionally fixed to the positions of central incisors on the upper and lower alveolar ridges (wax ridges) transferred from the buccal cavity of the patient, and by asking the patient to actually bite, the height and angle of the dentures may be adjusted so as to be an optimum state for the patient.

If ideal occlusion can be obtained, an occlusal curve suitable for the patient passing through contact points of these several dentures and the front edges of both mandibular condyles can be obtained.

That is, by preparing the base part of the denture base fitted to the jaws of the patient on the basis of the jaw model transferred from the buccal cavity of the patient, and fixing a plurality of dentures suitable for the patient at aesthetic locations within the buccal cavity of the patient in the anterior tooth portion of the upper jaw ridge body made on the base part, an inherent curvature radius is determined based on the plurality of dentures. And by fixing the denture row in one body according to the size of the circular arc on the ridge body surface drawn with this curvature radius, a desired denture base can be obtained. In order to measure the circular arc or determine the curvature radius, the arm 130 and the pawl 135 of the articulator 101 can be used.

In the above method for producing a denture base, a large number of dentures have to be fitted to the wax ridge along an occlusal curve. Therefore, troublesome work requiring much time and skill is needed. If this work can be simplified, it becomes far easier to produce a denture base, leading to much reduced producing time. Therefore, an improved producing method whereby this simplification can be realized is described below.

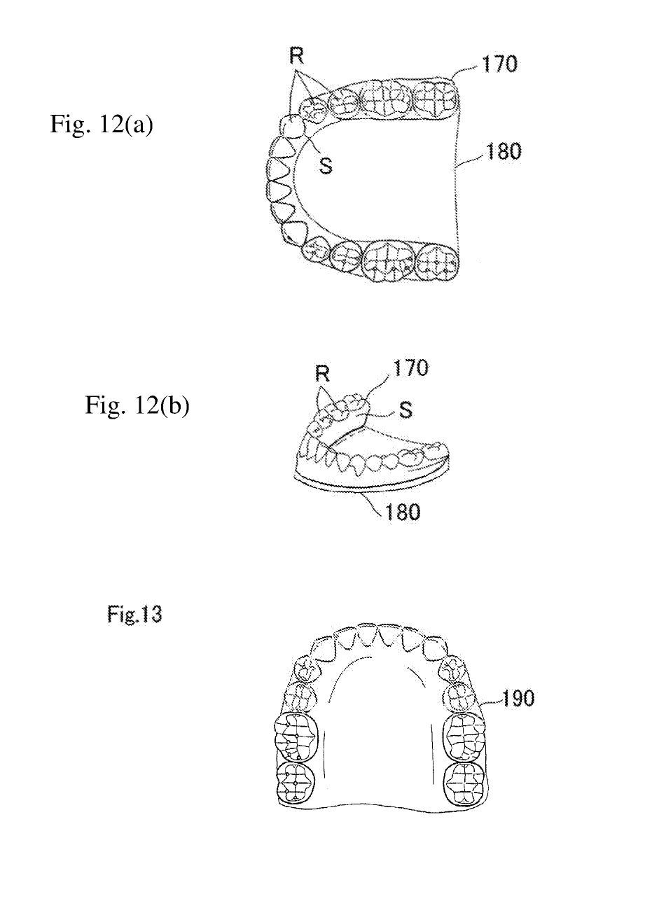

In this improved method, denture base components (tooth row units) 170 in which dentures are disposed along various occlusal curves to be fixed to a ridge body of a base member have been previously produced. FIG. 12 shows an example of the tooth row unit 170 as this denture base component, wherein dentures R are fixed to a ridge body S along an occlusal curve. The occlusal curve used for this denture arrangement of the tooth row unit 170 differs according to the age, body structure and the like of the patient, and there are also a great number of kinds of dentures. Therefore, in order for the patient to select the best one, the number of kinds of tooth row units is preferably as many as possible. However, too many kinds thereof cause increased stocks thereof and increased labor for management, leading to an uneconomical situation. It is preferable that the number of kinds thereof should be as small as possible within the range to be able to deal with changes in occlusion of patients. The number of kinds of tooth row units as denture base components to be prepared is preferably several tens or so, and realistically 30-50 kinds thereof is recommended.

From among the above prepared denture base components (tooth row units), the best one is selected in consideration of the patient's preference. And the selected tooth row unit is attached to a plastic base 180 (shown in FIG. 12) produced based on the model captured from the buccal cavity of the patient. In this case, the tooth row unit having a curve appropriate to the occlusal curve of the patient selected from among the above multiple kinds of tooth row units is arranged on a line three-dimensionally intersecting a curve passing through one point in the center portion of the condyle or one point 2-3 mm closer to the auditory meatus than that on an X-ray photograph of the temporal region of the patient, on the inherent dental arch plane determined within the buccal cavity of the patient, and is fixed on the base part. The concrete procedure of fixing is as follows. First, the model with the wax ridges split into the upper and lower portions along the occlusal curve is set on the articulator 101, and the upper tooth row unit 170 is set in a manner to fit on the lower teeth.

Then, the wax of the wax ridge of the upper jaw is removed, so that only the upper plastic base 180 remains. Between the plastic base 180 and the tooth row unit 170 placed on the lower jaw side, a high-quality instantly polymerized resin for dental use is poured to be polymerized. By this, a denture base 190 consisting of the plastic base 180 united with a denture row as shown in FIG. 13 can be obtained.

By such simplified denture base preparing method, the work wherein dentures are implanted on the plastic base 180 produced based on the shape of the buccal cavity of the patient each time is unnecessary, leading to extremely efficient producing of denture bases. And since the prepared tooth row is produced by implanting dentures along an occlusal curve in consideration of the vector of occlusion force of the patient, close-to-ideal occlusion can be obtained.

Using the zero moment adjuster (occlusion curved surface measuring device) 10 according to the above embodiment, with the fixing section 15 which can be attached to/detached from the one face-bow mounting part 12A, the face bow 13 can be fixed to the face-bow mounting parts 12A and 12B at a prescribed mounting angle, that is, an angle designed to allow the mouthpiece 14 to be positioned on the occlusion curved surface within the buccal cavity and at an occlusion height inherent in the patient. Consequently, it is possible to locate the mouthpiece 14 on the occlusion curved surface within the buccal cavity with ease and high precision, to measure the occlusion curve of the patient efficiently, to reproduce an ideal occlusion state inherent in the patient easily and in a short period of time, and to enhance the efficiency in dental treatment such as occlusion diagnosis.

Using the zero moment adjuster 10, by fitting the plurality of protrusion parts 15c provided in the fitting part 15a of the fixing section 15 and the protrusion part 13d provided at the end of the face bow 13 into the holes 12b formed in the hole formation part 12c of the face-bow mounting part 12A, the face bow 13 can be easily mounted on the face-bow mounting parts 12A and 12B at a prescribed mounting angle and at a position of the curvature radius (occlusal vertical dimension) inherent in the patient. As a result, the occlusion curve and occlusal vertical dimension inherent in the patient can be reproduced with ease and high precision by one-touch fitting.

Using the zero moment adjuster 10, the face bow 13 can be fixed to the face-bow mounting part 12A at a prescribed mounting angle by the fixing section 15 fixed to one end portion of the face bow 13. By the height indicating device 20 installed at the side frame 13b of the face bow 13, the mounting height of the face bow 13 can be adjusted with high accuracy. The face bow 13 can be easily mounted on the face-bow mounting parts 12A and 12B at a prescribed mounting angle θ₃ and at a position of the curvature radius (occlusal vertical dimension) inherent in the patient, and the occlusion curve and occlusal vertical dimension inherent in the patient can be reproduced with ease and high precision by one-touch fitting.

Using the zero moment adjuster 10 according to the embodiment, it is possible to extremely efficiently produce a denture base by which occlusion assumed to be most preferable for each patient can be obtained. Using the zero moment adjuster 10, the measurement time of the occlusion state can be reduced, diagnoses or treatment can be finished in a short period of time, and since problems within the buccal cavity can be correctly grasped in one diagnosis, the treatment period can be shortened and the number of times of outpatient care can be reduced, leading to reduced burden on the patient. In addition, since the position, size, and atypia of the upper jaw dental arch can be precisely examined simultaneously, so that abnormal occlusion can be visually grasped, high medical effects in various clinical stages such as “inlay”, “crown bridge”, “denture”, “implant”, “correcting teeth”, “temporomandibular joint arthrosis”, and “jaw cutting operation” can be delivered.

Combined with the articulator 101, an ideal prosthesis having an occlusion curve inherent in a patient can be produced. And since it becomes possible to conduct prosthesis processing in a patient's lying state, it is optimal for producing dentures of bedridden old people and treatment on people with disabilities, leading to dramatically improved QOL.

Here, the denture base made of resin was mainly explained above, but it is needless to say that a denture base made of metal can also be produced with the same principle.

### INDUSTRIAL APPLICABILITY

The present invention, relating to a zero moment adjuster (also called an occlusion curve measuring device, or an occlusion contact position measuring device), can be widely used in dental treatment such as improper occlusion, edentulous jaw, and oligodontia.

### DESCRIPTION OF REFERENCE SIGNS

10: Zero moment adjuster
11: Base frame
11a, 11b: Side frame
11c: Lateral frame
12A, 12B: Face-bow mounting part
12a: Fixed part
12b: Hole
12c: Hole formation part
13: Face bow
13a, 13b: Side frame
13c: Lateral frame
13d: Protrusion part
14: Mouthpiece
14a: Mounting part
14b: Mouthpiece part
14c: Supporting part
15: Fixing section
15a: Fitting part
15b: Holding part
15c: Protrusion part
16: Earpiece mounting part
17: Earpiece
18: Pad part
19: Reference point indicating device
20: Height indicating device
21: Pad fitting part
θ₃: Prescribed mounting angle

1. A zero moment adjuster, comprising:
a base frame having a pair of left and right side frames arranged along both sides of the head of a patient and a lateral frame connecting between the pair of left and right side frames;
face-bow mounting parts attached to the side frames;
a face bow, being detachably mounted on the face-bow mounting parts;
a mouthpiece mounted on the face bow to be inserted into the buccal cavity of the patient;
a fixing section for fixing the face bow on the face-bow mounting parts at a prescribed mounting angle, being detachably fitted to the face-bow mounting part;
earpiece mounting parts installed at the side frames;
earpieces mounted on the earpiece mounting parts;
a pad part for supporting the base frame to be applied in the neighborhood of between the eyebrows of the patient, being provided in a center portion of the lateral frame; and
a reference point indicating part for indicating an occlusion force concentration portion set in the neighborhood of the nasion of the patient, being provided in the center portion of the lateral frame, wherein
the mouthpiece is formed in the shape of a curved surface along an occlusion spherical surface whose center is a point on an occlusion line passing through the occlusion force concentration portion and being parallel to the side frames, and
the prescribed mounting angle is an angle designed to allow the mouthpiece to be positioned on an occlusion curved surface within the buccal cavity.

2. The zero moment adjuster according to claim 1, wherein
the face-bow mounting part has:
a fixed part to be fixed to the side frame; and
a hole formation part in which a plurality of holes for adjusting the mounting position of the face bow are formed,
the fixing section has:
a fitting part which can be fitted to the hole formation part; and
a holding part for holding the face bow at the prescribed mounting angle, and
on the fitted surface of the fitting part, a plurality of protrusion parts which can be engaged in the plurality of holes in the hole formation part are formed, and a protrusion part provided at the end of the face bow is also arranged.

3. The zero moment adjuster according to claim 1, wherein
the face bow is formed approximately in a U-shape,
at one end of the face bow, the fixing section is fixed, and
at the other end of the face bow, a height indicating device for indicating a mounting height of the face bow, being rotatable to the face bow, is provided.

4. The zero moment adjuster according to claim 2, wherein
the face bow is formed approximately in a U-shape,
at one end of the face bow, the fixing section is fixed, and
at the other end of the face bow, a height indicating device for indicating a mounting height of the face bow, being rotatable to the face bow, is provided.
